(19) United States
(12) Patent Application Publication
(10) Pub. No.: US 2006/0176836 A1
(43) Pub. Date: Aug. 10, 2006

(54) Method and apparatus for reducing leeches on a P2P network

(76) Inventors: Raymond B. Jennings III, Ossining, NY (US); Jason D. LaVoie, Mahopac, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/050,956

(22) Filed: Feb. 4, 2005

(51) Int. Cl. H04L 5/22

(52) U.S. Cl. 370/299

(57) ABSTRACT

One embodiment of the present method and apparatus for reducing leeches on a P2P network includes receiving a data request message and at least one reference from a requesting node, where the reference pertains to at least one previous data transfer in which the requesting node has engaged. The reference is then verified and it is determined, in accordance with the reference, whether to provide the requested data to the requesting node.

### BACKGROUND

The present invention relates generally to computing networks and relates more particularly to the reduction of leeches on data transfer networks.

FIG. 1 is a schematic diagram of a network 100 of nodes (e.g., computing devices) interacting in a peer-to-peer (P2P) manner. Generally, a requesting node 101 sends a search message 105 (e.g., containing keywords relating to data that the requesting node 101 wishes to locate) to at least one intermediate node 111 in communication with the requesting node 101 via a peer connection. The intermediate node 111 receives the search message 105 and then, if the intermediate node 111 does not have the requested data, forwards the search message 105 to at least one additional node 111. Eventually, the search message 105 reaches at least one responding node 103 having the requested data (in some cases, the first intermediate node 111 to which the search message 105 is forwarded will also be a responding node 103). At least one responding node 103 then sends a response message 107 back to the requesting node 101, e.g., via the intermediate nodes 111. The requesting node 101 then requests the relevant data from a responding node 103 by connecting directly to the responding node 103, e.g., via direct connection 109, and downloading the data over the connection 109.

For a P2P network to be successful, it is important that all nodes 101, 103, 111 participate in a relatively equal manner with respect to sharing data (e.g., by uploading as well as downloading data). However, it is not uncommon for several “leeches” (i.e., nodes that download data from other nodes but do not reciprocate by providing their own data for download) to be present in the network. These leeches typically offer no benefit to a P2P network, and only serve to drain network resources at the expense of other users. Although methods are known for identifying leeches, such as flagging users that do not share a threshold amount of data, these methods are easily circumvented by either falsifying records of data shared or by creating fake data. Moreover, such methods do not actually prevent leeches from using network resources.

Thus, there is a need in the art for a method and apparatus for reducing leeches on a P2P network.

### SUMMARY OF THE INVENTION

One embodiment of the present method and apparatus for reducing leeches on a P2P network includes receiving a data request message and at least one reference from a requesting node, where the reference pertains to at least one previous data transfer in which the requesting node has engaged. The reference is then verified and it is determined, in accordance with the reference, whether to provide the requested data to the requesting node.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a network of nodes interacting in a peer-to-peer manner;

FIG. 2 is a flow diagram illustrating one embodiment of a method for reducing leeches on a P2P network, such as the network illustrated in FIG. 1;

FIG. 3 is a flow diagram illustrating one embodiment of a method for requesting data over a P2P network in accordance with the present invention; and

FIG. 4 is a high level block diagram of the leech detection method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for reducing leeches (e.g., a number of leeches or an amount of leeching) on a P2P network. Embodiments of the present invention enable nodes within a P2P network to determine whether a requesting node (e.g., a node that is requesting data) is participating in the network in an unfair manner (e.g., by not providing data for download by others). A node may then decide, based on the nature of the requesting node's participation in the network, whether to provide the requested data for download by the requesting node.

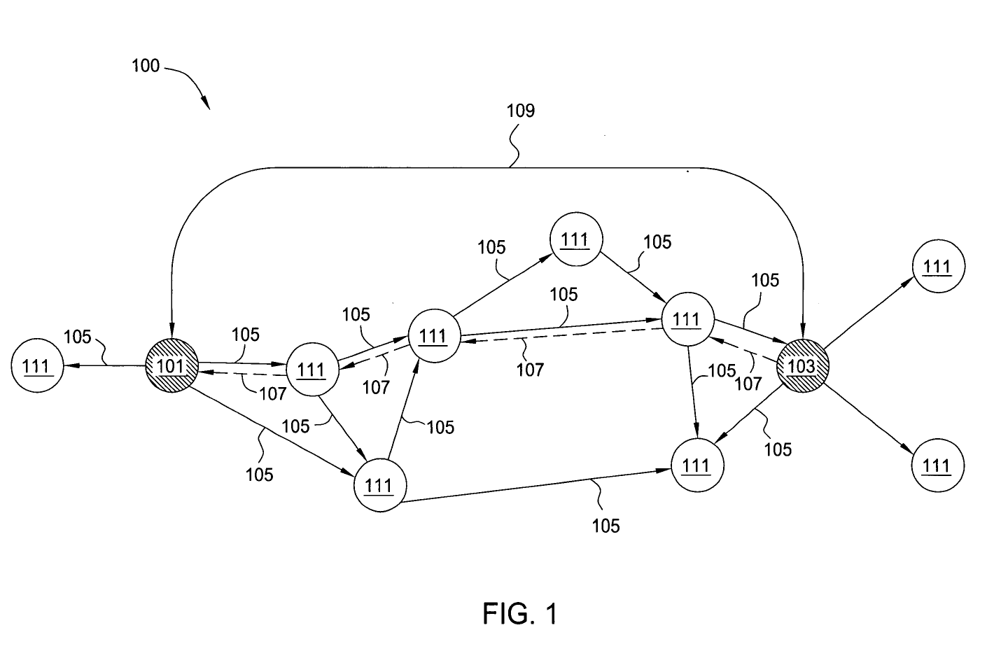

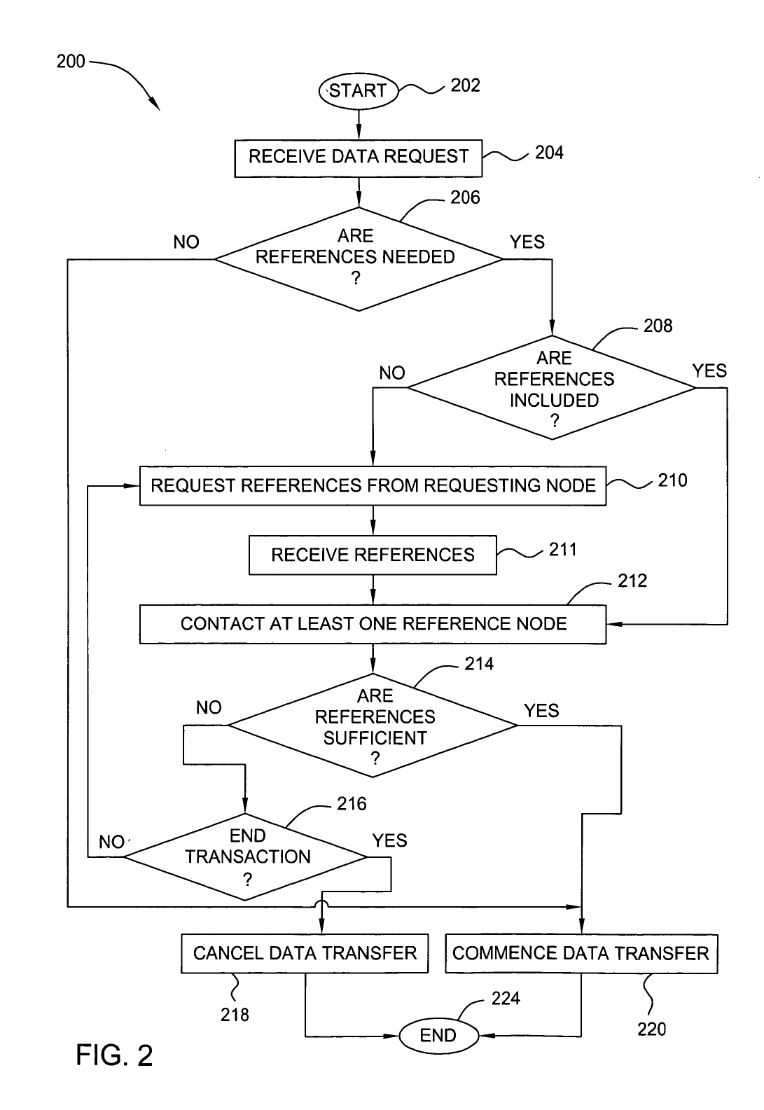

FIG. 2 is a flow diagram illustrating one embodiment of a method 200 for reducing leeches on a P2P network, such as the network 100 illustrated in FIG. 1. The method 200 may be implemented, for example, at a responding node such as responding node 103. The method 200 is initialized at step 202 and proceeds to step 204, where the method 200 receives a data request (e.g., a request to download data from the responding node) from a requesting node.

In step 206, the method 200 determines whether the requesting node needs to provide references before downloading the requested data. The references are intended to verify that the requesting node is participating in the P2P network in a fair manner (e.g., by sharing bandwidth with uploads as well as downloads). In one embodiment, the references include information pertaining to one or more data transfers that the requesting node has previously executed in conjunction with other nodes (hereinafter “reference nodes”) on the network. For example, a reference provided by a requesting node may include the identity of a reference node to or from which data was transferred and any meta-data specific to the data that was transferred. In one embodiment, this meta-data includes any information associated with a previous data transfer, such as the name of the transferred data, the type of the transferred data, the size of the transferred data, the date and time of the data transfer, the duration of the data transfer and an offset number into a data library.

Thus, in step 206, the method 200 determines whether such references are needed to verify that the requesting node has been participating in the P2P network in a fair manner. In one embodiment, this determination is made based at least in part on an amount of data that the requesting node is requesting (e.g., if the requesting node asks for more than x files, references are needed). In another embodiment, this determination is based at least in part on the current level of network activity. For example, during peak periods where a limited (e.g., below a predefined threshold) amount of network resources (e.g., bandwidth) may be available, or where a number of currently active downloaders may exceed a predefined threshold, the method 200 may determine that references are needed. Alternatively, during off-peak periods where the current level of network activity may be low (e.g., network resource consumption or a number of currently active downloaders is below a predefined threshold), the method 200 may proceed directly with a requested data transfer and not request or check references.

If the method 200 determines that such references are not needed, the method 200 proceeds directly to step 220 and commences the transfer of the requested data (e.g., providing other technical requirements such as bandwidth limitations and available peer connections are met).

Alternatively, if the method 200 determines that such references are needed, the method 200 proceeds to step 208 and determines whether the requesting node has included references in the data request. In some embodiments, a requesting node may automatically include a predefined number of references (e.g., the last n uploads) in a data request (or as a separate message accompanying the data request). In one embodiment, the requesting node chooses when to automatically include these references; for example, references may be included in every data request that is sent, or may be included only in any data request that requests data exceeding a threshold size.

If the method 200 determines in step 208 that references were not included in the data request, the method 200 proceeds to step 210 and requests that the requesting node send references. In step 211, the method 200 receives the requested references from the requesting node. The method 200 then proceeds to step 212 and contacts at least one reference node that is included in the requesting node's references. Alternatively, if the method 200 determines in step 208 that the references were included in the original data request, the method 200 may proceed directly from step 208 to step 212.

In one embodiment, the method 200 contacts the at least one reference node (e.g., a node that has been implicated in a reference as having engaged in a data transfer with the requesting node) in step 212 in order to verify that the information that the requesting node provided regarding previous data transfers is accurate. In one embodiment, the method 200 may, in step 212, send a summary of the data transfer in question (e.g., including all of the details provided in the reference) to the reference node and ask the node to respond with a simple yes or no answer indicating the accuracy of the summary. Alternatively, the reference node may respond with corrections to the summary. For example, the requesting node may have stated in the summary that it uploaded five megabytes of data to the reference node, when, in fact, the reference node only received four megabytes from the requesting node. In one embodiment, the summary may omit certain information, such as the content of the transferred data, for privacy.

In step 214, the method 200 determines, based on the response from the at least one reference node, whether the requesting node has sufficiently demonstrated that it is participating in the P2P network in a fair manner. In one embodiment, this determination is made either manually or automatically. For example, the method 200 may display the information to a user, who will determine whether or not to allow the requesting node to download the requested data. Alternatively, the method 200 may implement an automatic threshold that determines sufficiency of references based on, for example, a number of verified data transfers in which the requesting node has engaged, the sizes of verified data transfers, the type of data transferred, how recent the verified data transfers were, or the speeds of the data transfers. These criteria can be implemented on a cumulative basis (e.g., any one or more references in combination may satisfy the total threshold), or they can be required for each individual reference (in which case the method 200 may further specify a minimum number of individual references that must meet these criteria). Moreover, these criteria may be applied to a specified finite amount of time or to an infinite amount of time.

If the method 200 concludes that the requesting node has sufficiently demonstrated that it is participating in the P2P network in a fair manner, the method 200 proceeds to step 220 and commences the requested data transfer. Alternatively, if the method 200 concludes that the requesting node has not sufficiently demonstrated that it is participating in the P2P network in a fair manner, the method 200 proceeds to step 216 and determines whether the transaction should be ended as a consequence. In one embodiment, the method 200 may specify that if a requesting node's references are not sufficient upon a first review, the transaction should automatically be cancelled, in which case the method 200 proceeds to step 218 and cancels the requested data transfer.

Alternatively, the method 200 may specify that if a requesting node's references are not sufficient upon a first review, the requesting node may submit additional references in a second attempt to meet the method 200's criteria (e.g., as specified in step 214). Thus, if the method 200 determines in step 216 that the transaction should not be automatically ended due to insufficiency of the requesting node's references, the method 200 returns to step 210 and requests additional references from the requesting node. The method 200 may also decide to request additional references if one or more of the references already provided is not currently available (e.g., is offline). The method 200 then proceeds as described above with respect to steps 210-216.

The method 200 terminates in step 224.

The method 200 thereby enables a node from which a requesting node is requesting data to easily determine whether the requesting node is a leech that has failed to participate in the P2P network in a fair manner. By requiring a requesting node to provide references relating to previous data transfers, a node can verify that the requesting node has been providing data to the network in addition to downloading data from the network. If it is determined that the requesting node has not provided a sufficient amount of data for download by others (e.g., in proportion to data that the requesting node has downloaded from others), a node may decline to provide the requesting node with the requested data, thereby limiting the requesting node's access to valuable network resources.

Those skilled in the art will appreciate that in some cases, the method 200 may choose to bypass steps 212-218. For example, during network usage periods that fall between peak and off-peak, the method 200 may ask for references, but then simply discard or decline to verify the references (e.g., in an attempt just to “call the requesting node's bluff”). Alternatively, in the example where references are required based on the amount of data requested, the method 200 may request references if the amount of data requested exceeds a first predefined threshold, but verify the references only if the amount of data requested exceeds a second predefined threshold. Bypassing steps 212-218 would also allow for new member nodes that do not yet have a large data transfer history to receive data.

Moreover, those skilled in the art will appreciate that if the method 200 concludes that the requesting node has not sufficiently demonstrated that it is participating in the P2P network in a fair manner, the method 200 may allow the data transfer to proceed with limited bandwidth rather than cancel the data transfer outright. In this manner, the method 200 can allow new member nodes to participate in the P2P network, as well as reward requesting nodes that can provide appropriate references with higher bandwidth and/or faster response times.

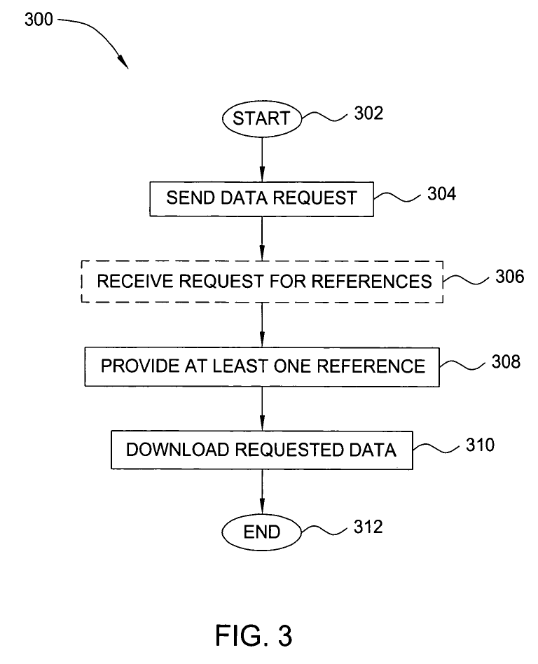

FIG. 3 is a flow diagram illustrating one embodiment of a method 300 for requesting data over a P2P network in accordance with the present invention. The method 300 may be implemented at, for example, a requesting node that has received a response message indicating a node having requested data.

The method 300 is initiated at step 302 and proceeds to step 304, where the method 300 sends a data request to a responding node that has the requested data. The method 300 then proceeds to optional step 306 (illustrated in phantom) and receives a request for references from the responding node. Step 306 is described as optional because, in some embodiments, the responding node may not request references as a condition of providing the requested data. In one embodiment, the reference request includes specific reference criteria that the responding node is seeking, such as a specified number of references or evidence of a specified amount of data transferred.

In step 308, the method 300 provides at least one reference to the responding node. In one embodiment, the reference is provided in response to a request for references (e.g., as received in optional step 306). In another embodiment, the method 300 may provide the reference automatically. In this embodiment, the reference may be provided in the data request or in a separate message that accompanies or follows the data request.

In step 310, assuming that the references provided in step 308 are considered sufficient by the responding node (or that no references are required), the method 300 downloads the requested data from the responding node. The method 300 then terminates in step 312.

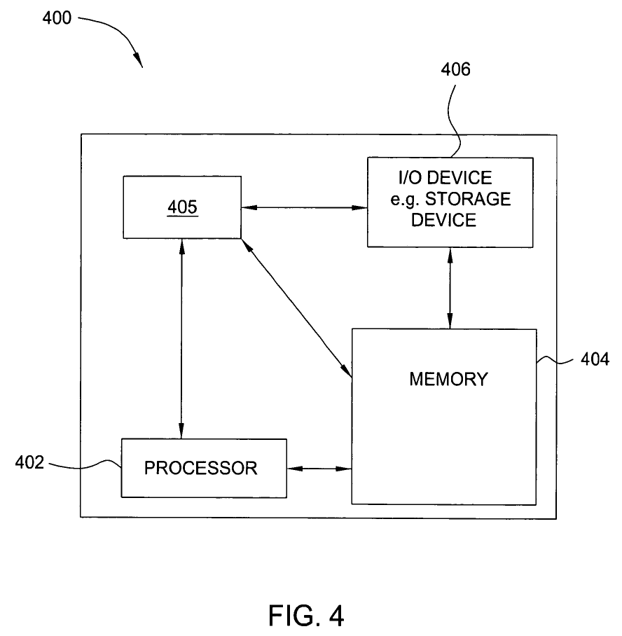

FIG. 4 is a high level block diagram of the leech detection method that is implemented using a general purpose computing device 400. In one embodiment, a general purpose computing device 400 comprises a processor 402, a memory 404, a leech detection module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the leech detection module 405 can be implemented as a physical device or subsystem that is coupled to a processor through a communication channel.

Alternatively, the leech detection module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the leech detection module 405 for detecting leeches in a P2P network described herein with reference to the preceding Figures can be stored on a computer readable medium or carrier (e.g., RAM, magnetic or optical drive or diskette, and the like).

Thus, the present invention represents a significant advancement in the field of data transfer networks. A method and apparatus are provided that make it possible for a node on a P2P network to determine whether a node that is requesting data is likely to be a leech, e.g., by requiring the requesting node to provide references verifying previous data transfers in which the requesting node has engaged. A node may then decide, based on an assessment of the requesting node's data transfer history, whether or not to provide the requested data for download by the requesting node. In this manner, a node can reduce the amount of network resources that are consumed by nodes that fail to participate in the network in a fair manner.

While foregoing is directed to the preferred embodiment of the present invention, other and further embodiments of the invention may be devised without departing from the basic scope thereof, and the scope thereof is determined by the claims that follow.

1. A method for transferring data from a first node to a second node in a network, said method comprising the steps of:
receiving a data request message from said second node, said data request message requesting data residing at said first node;
verifying at least one reference pertaining to at least one previous data transfer in which said second node has engaged; and
determining, in accordance with said at least one reference, whether to provide said requested data to said second node.

2. The method of claim 1, wherein said at least one reference includes at least one of: an identity of a reference node to or from which data was transferred in said at least one previous data transfer, a type of data transferred in said at least one previous data transfer, a date of said at least one previous data transfer, a time of said at least one previous data transfer, a duration of said at least one previous data transfer, a name of data was transferred in said at least one previous data transfer and an offset number into a data library.

3. The method of claim 2, wherein said verifying comprises:
contacting said reference node to verify an accuracy of said at least one reference.

4. The method of claim 3, wherein said contacting comprises:
sending at least a portion of said at least one reference to said reference node; and
receiving feedback from said reference node indicative of said accuracy of said at least one reference.

5. The method of claim 4, wherein said feedback comprises a yes or no answer indicating whether said at least a portion of said at least one reference is accurate or not accurate.

6. The method of claim 4, wherein said feedback comprises corrections to said at least a portion of said at least one reference.

7. The method of claim 1, wherein said at least one reference is received with said data request message.

8. The method of claim 1, wherein said at least one reference is received in response to a reference request sent to said second node.

9. The method of claim 1, wherein said determining comprises:
concluding, based on said at least one reference, whether said second node has participated in said network in a fair manner; and
providing said requested data to said second node only if said second node is considered to have participated in said network in a fair manner.

10. The method of claim 9, wherein said providing step further comprises:
limiting a bandwidth for providing said requested data to said second node if said second node cannot demonstrate that said second node has participated in said network in a fair manner.

11. The method of claim 9, wherein said second node has participated in said network in a fair manner if said second node meets a threshold in accordance with at least one previous data transfer.

12. The method of claim 9, wherein said threshold is based on criteria including at least one of: a minimum number of other nodes to which said second node has transferred data, a minimum number of other nodes to which said second node has transferred data within a specified amount of time, a minimum size of data transferred by said second node, a minimum size of data transferred by said second node within a specified amount of time, a type of data transferred by said second node, how recently said at least one previous data transfer occurred and how quickly said at least one previous data transfer was executed.

13. The method of claim 12, wherein said criteria is applied to each of said at least one reference.

14. The method of claim 12, wherein said criteria is applied to a cumulative number of references.

15. The method of claim 1, wherein said determining step comprises:
concluding, based on said at least one reference, that said second node is new to said network; and
providing at least a portion of said requested data to said second node.

16. The method of claim 15, wherein said providing comprises:
limiting an amount of bandwidth at which said requested data is provided to said second node.

17. A computer readable medium containing an executable program for transferring data from a first node to a second node in a network, where the program performs the steps of:
receiving a data request message from said second node, said data request message requesting data residing at said first node;
verifying at least one reference pertaining to at least one previous data transfer in which said second node has engaged; and
determining, in accordance with said at least one reference, whether to provide said requested data to said second node.

18. The computer readable medium of claim 17, wherein said at least one reference includes at least one of: an identity of a reference node to or from which data was transferred in said at least one previous data transfer, a type of data transferred in said at least one previous data transfer, a date of said at least one previous data transfer, a time of said at least one previous data transfer, a duration of said at least one previous data transfer, a name of data was transferred in said at least one previous data transfer and an offset number into a data library

19. The computer readable medium of claim 17, wherein said determining comprises:
concluding, based on said at least one reference, whether said second node has participated in said network in a fair manner; and
providing said requested data to said second node only if said second node is considered to have participated in said network in a fair manner.

20. Apparatus comprising:
means for receiving a data request message from said second node, said data request message requesting data residing at said first node;
means for verifying at least one reference pertaining to at least one previous data transfer in which said second node has engaged; and
means for determining, in accordance with said at least one reference, whether to provide said requested data to said second node.
